(19) United States
(12) Patent Application Publication
(10) Pub. No.: US 2007/0114482 A1
(43) Pub. Date: May 24, 2007

(54) Electromagnetically driven valve and method for driving the same

(75) Inventors: Masahiko Asano, Toyota-shi (JP); Yutaka Sugie, Nishikamo-gun (JP)

Correspondence Address: KENYON & KENYON LLP, 1500 K STREET N.W., SUITE 700, WASHINGTON, DC, 20005, US

(73) Assignee: Toyota Jidosha Kabushiki Kaisha

(21) Appl. No.: 11/593,023

(22) Filed: Nov. 6, 2006

(30) Foreign Application Priority Data
Nov. 24, 2005 (JP) 2005-338616

(51) Int. Cl. F16K 31/02

(52) U.S. Cl. 251/129.16

(57) ABSTRACT

An electromagnetically driven valve includes: a valve reciprocating to and fro along a direction in which the valve shaft extends; a disk connected to the valve; a first electromagnet including a first coil; a torsion bar, which is a first elastic member; and an ECU which controls the electromagnet force of the first electromagnet. This ECU controls electrical current so as, when weakening the electromagnetic force of the first electromagnet and separating the disk from the first electromagnet, to reduce the electrical current which flows in the first coil towards zero, after having temporarily increased it from a first holding current to a second holding current which is larger than the first holding current, and then, after the disk has separated from the first electromagnet, so as to flow a braking current for adjusting the speed of the disk.

The disclosure of Japanese Patent Application No. 2005-338616 filed on Nov. 24, 2005, including the specification, drawings and abstract is incorporated herein by reference in its entirety.

### BACKGROUND OF THE INVENTION

1. Field of the Invention

The present invention relates to an electromagnetically driven valve and a method for driving an electromagnetically driven valve, and in particular relates to an electromagnetically driven valve which is used as an intake valve or an exhaust valve of an internal combustion engine and a method for driving such an electromagnetically driven valve.

2. Description of the Related Art

In relation to a related art electromagnetically driven valve of an internal combustion engine, for example, a single-coil type electromagnetically driven valve is described in Japanese Laid-Open Patent Publication No. 11-101110: in this publication, there is disclosed a valve in which movable plates are provided on both sides of an electromagnet, and these movable plates are integrally formed with a valve. In this example, in the neutral position, one or the other of the gaps between the electromagnet and the movable plates on both sides thereof is the narrower. In the initial state in which no electrical current is flowing in the coil, the valve is in its neutral position; while, when an electrical current flows through the coil, that one of the movable plates is attracted against the electromagnet, for which the gap between it and the electromagnet is the narrower. And, when the electrical current is temporarily interrupted, the valve is pushed in the opposite direction (for example from the fully closed state to the fully open state) by a valve spring, and, due to the force of its inertia, it carries on moving past its neutral position. When, at this time, the electrical current is again flowed through the coil, due to the electromagnetic force, the movable plate on the opposite side is held.

Although there are many electromagnetically driven valves for internal combustion engines in which the required electromagnetic force is generated by driving a coil with a power supply voltage of, for example, around 42 volts, investigations have been recently undertaken for reducing costs by simplifying the structure of the power supply system, due to the fact that nowadays power supply voltages are being reduced down to about 14 volts.

When driving an electromagnetically driven valve with such a reduced voltage, it is necessary to improve the responsiveness of the electromagnet of the electromagnetically driven valve, because it is not possible to obtain the required braking electrical current, due to diminution of the current rising slope response.

### SUMMARY OF THE INVENTION

FIG. 8 is a figure showing a research example of an electromagnetic actuator used in such an electromagnetically driven valve, and FIG. 9 is a figure showing a region around a coil 182 of FIG. 8 in magnified view.

In the research example shown in FIGS. 8 and 9, this electromagnetic actuator 124 includes an electromagnet for opening the valve, fixed to a housing 162, an electromagnet for closing the valve, and a disk 174 which oscillates between these two electromagnets. One side of this disk 174 is fixed to the housing 162 so as to swivel around a torsion bar 168 as an axis.

The electromagnet for closing the valve includes a core 172 for closing the valve, which is fixed to the housing 162, and a coil 180 which is wound using two grooves provided in this core 172 for closing the valve.

The electromagnet for opening the valve similarly includes a core 178 for opening the valve, which is fixed to the housing 162, and a coil 182 which is wound using two grooves provided in this core 178 for opening the valve.

The coil 180 and the coil 182 are wired together, thus constituting a monocoil structure. It should be understood that it would also be acceptable to control the electrical currents in the coil 180 and the coil 182 individually, i.e. not employing such a monocoil structure.

And, due to the elastic force of the torsion bar 168, which is an upper spring, and which acts against the force of a lower spring not shown in the figure, the disk 174 exerts a force upon an intermediate stem 176 in the downwards direction in the figure, in other words, in the direction to open the valve. A cam follower tip is fitted to the other end of the disk 174. This cam follower tip contacts against a cam follower pin which is fixed to the upper end of the intermediate stem 176, and thereby exerts a force on the intermediate stem 176 in the downward direction in the figure, in other words in the direction to open the valve.

Against this, a force is exerted upon the intermediate stem 176 in the upwards direction by the lower spring not shown in the figure pressing upon the intermediate stem 176 from below, in other words in the direction to close the valve.

When an electrical current flows in the coil 182 as shown in FIG. 9, magnetic flux lines 194 are generated, and the disk 174 is attracted. However since, as shown by the portion 196 of this figure, the bottom corner 197 of the coil groove 192 provided in the core 178 for opening the valve is approximately a right angle, the intervals between the magnetic flux lines become narrow at this angular portion, and the magnetic saturation occurs. Due to this, the problem occurs that this invites a decrease in the electromagnetic force, and a decrease in the responsiveness of the electromagnetic force.

FIG. 10 is a waveform diagram showing an example of research into the conduction pattern of the coil. In this figure, between the time points t10˜t12, a holding current flows in the coil, and the valve is maintained in the valve closed state. And, when at the time point t12 the holding current is decreased, the valve starts to shift from the valve closed position towards the valve open position. At this time, sometimes a requirement arises to change the lift amount of the valve open position from the time point t14 onwards, as for example from a seated position D0 to a hovering position D1 or to a slightly lifted position D2.

When at the time point t12 the attractive force of the electromagnet ceases, the disk is impelled in the valve opening direction by the torsion bar 168, but, if the energy imparted by the torsion bar 168 is too great, the valve may continue onward and stop past its target stopping position, so that the accuracy of positional control becomes poor. Accordingly, a braking current is flowed in the coil, in order to generate a force (a braking force) in the electromagnet to hinder the force of the torsion bar 168. However, when the voltage of the power supply of the drive unit which supplies electrical current to the coil is decreased to 14 volts, the rise slope responsiveness of the current decreases, and it is no longer possible to obtain the desired braking current, so that the problem arises that it is no longer possible to perform hovering lift control or slightly lifted control.

Thus, an object of the present invention is to provide an electromagnetically driven valve, in which the responsiveness of the electromagnetic force is improved.

A first aspect of the present invention relates to an electromagnetically driven valve, including: a valve, including a valve shaft, which reciprocates to and fro along a direction in which the valve shaft extends; a magnetic member which is connected to and drives the valve; a first electromagnet, including a first coil, which attracts the magnetic member and keeps it in a predetermined position; a first elastic member which applies, to the magnetic member, a force to remove the magnetic member from the first electromagnet; and a control device which controls the electromagnetic force of the first electromagnet; wherein the control device performs electrical current control so as, when weakening the electromagnetic force of the first electromagnet and separating the magnetic member from the first electromagnet, to reduce the electrical current which flows in the first coil towards zero, after having temporarily increased it from a first holding current to a second holding current which is larger than the first holding current, and then, after the magnetic member has separated from the first electromagnet, so as to flow a braking current for adjusting the speed of the magnetic member.

This electromagnetically driven valve is a valve which opens and closes a gas conduit to a combustion chamber of an internal combustion engine, and the value of the second holding current may be determined according to the load of the internal combustion engine.

The electromagnetically driven valve further comprises a drive unit which drives an electrical current to flow in the first coil, and a DC power supply which supplies DC power voltage to the drive unit; and the value of the second holding current may be determined according to the power supply voltage.

The value of the second holding current may be determined according to the temperature of the environment in which the electromagnetically driven valve operates.

The value of the second holding current may be determined according to a target position for the valve to be stopped, after the magnetic member has been separated from the first electromagnet.

There may be further included a magnetic material core in which is provided a coil groove, in which at least a portion of the first coil is housed; and: the core may attract the magnetic member towards an open side portion of the coil groove; and the coil groove may have an approximately quadrilateral shape in cross section in a direction orthogonal to the winding direction of the coil, and its corner portions, at the bottom portion of the opposite side of the quadrilateral to the open side portion thereof, may be radiused.

A second aspect of the present invention relates to an electromagnetically driven valve, including: a valve, including a valve shaft, which reciprocates to and fro along a direction in which the valve shaft extends; a magnetic member which is connected to and drives the valve; a first electromagnet, including a first coil, which attracts the magnetic member and keeps it in a predetermined position; a first elastic member which applies, to the magnetic member, a force to remove the magnetic member from the first electromagnet; and a core of magnetic material, in which a coil groove is provided which houses at least a portion of the first coil; and wherein: the core attracts the magnetic member towards an open side portion of the coil groove, and the core groove has an approximately quadrilateral shape in cross section in a direction orthogonal to the winding direction of the coil, and its corner portions, at the bottom portion of the opposite side of the quadrilateral to the open side portion thereof, are radiused.

The magnetic member may be a oscillating member, one end of which is supported so as to swivel freely upon a base member, and which is provided, at its other end, with an operation portion which reciprocates the valve shaft to and fro along the direction in which the valve shaft extends.

The predetermined position may be a valve closed position, and there may be further included: a second electromagnet which attracts the magnetic member and holds it in a valve open position; and a second elastic member which, by exerting an elastic force on the valve shaft, exerts a force on the magnetic member to remove the magnetic member from the second electromagnet.

The second electromagnet may include a second coil which is wired up to the first coil, and equal electrical currents may flow in the first coil and in the second coil.

The control device may perform control, after having reduced the electrical current which flows in the first and second coils to zero from a predetermined current value for holding current, so as to flow in the first and second coil a current for attracting the magnetic member against the second electromagnet.

According to the present invention, it is possible to enhance the responsiveness of the electrical current control even at low voltage, so that it is possible to enhance the accuracy of valve positional control.

A third aspect of the present invention relates to a method for driving an electromagnetically driven valve including: a valve, including a valve shaft, which reciprocates to and fro along a direction in which said valve shaft extends; a magnetic member which is connected to and drives said valve; a first electromagnet, including a first coil, which attracts said magnetic member and keeps it in a predetermined position; a first elastic member which applies, to said magnetic member, a force to remove said magnetic member from said first electromagnet.

This method includes the steps of: when weakening the electromagnetic force of said first electromagnet and separating said magnetic member from said first electromagnet, temporarily increasing the electric current from a first holding current to a second holding current which is larger than said first holding current; reducing the electrical current which flows in said first coil towards zero to weaken the electromagnetic force of said first electromagnet and thus separate said magnetic member from said first electromagnet; and, after said magnetic member has separated from said first electromagnet, flowing a braking current for adjusting the speed of said magnetic member.

According to this method, it is possible to enhance the responsiveness of the electrical current control even at low voltage, so that it is possible to enhance the accuracy of valve positional control.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a figure schematically showing the structure of an electromagnetically driven valve according to an embodiment of the present invention;

FIG. 2 is a sectional view of the FIG. 1 structure, taken in a plane shown by the arrows II-II in FIG. 1;

FIG. 3 is a magnified view of a portion S of FIG. 1;

FIG. 4 is a figure for explanation of the relationship between an electromagnetic braking force Fb and a spring force Fs;

FIG. 5 is a figure for explanation of parameters related to braking electrical current;

FIG. 6 is a waveform diagram for explanation of changes of the electrical current flowing in a coil;

FIG. 7 is a figure showing an example of a map which determines increase amount of a holding electrical current;

FIG. 8 is a figure showing a research example of an electromagnetic actuator used in this electromagnetically driven valve;

FIG. 9 is a figure showing a region around a coil 182 of FIG. 8 in magnified view; and

FIG. 10 is a waveform diagram showing a research example of the conduction pattern of a coil.

### DETAILED DESCRIPTION OF THE PREFERRED EMBODIMENTS

In the following, the present invention will be explained in detail with reference to the drawings. It should be understood that, in the figures, portions which are the same or which correspond to one another are designated by the same reference numerals.

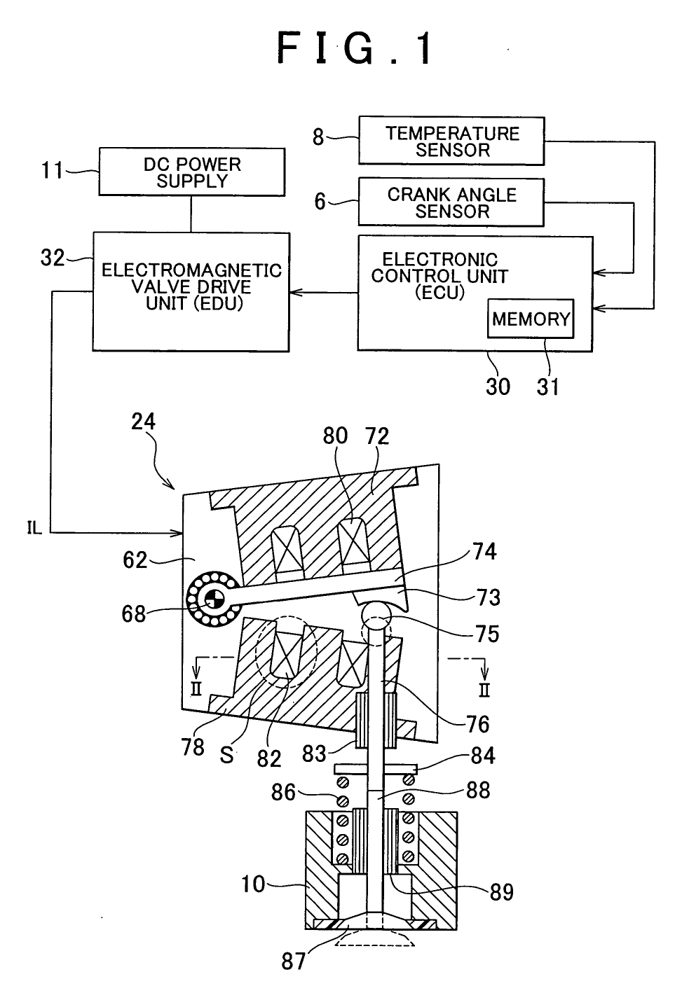

FIG. 1 is a figure schematically showing the structure of an electromagnetically driven valve according to an embodiment of the present invention. An engine, which is an internal combustion engine, includes a cylinder block, a cylinder head, pistons which reciprocate upwards and downwards within cylinders in the cylinder block, intake valves of an electromagnetic drive, type which are provided to intake ports of each of the cylinders, and exhaust valves of an electromagnetic drive type which are provided to exhaust ports of each of the cylinders. For example, two each of the intake valves and the exhaust valves may be provided to each of the cylinders.

In FIG. 1, a representative one of these electromagnetically driven valves is shown. A crank angle sensor 6 is fitted to this engine cylinder block, and detects the rotational speed of the engine. Various sensor outputs, such as the output of this crank angle sensor 6 and so on, are inputted to an electronic control unit (ECU) 30, and this ECU 30, along with controlling the injection timing and the injection amount of a fuel injection valve, and the ignition timing of a spark plug, also commands to an electromagnetic valve drive unit (EDU) 32 the valve opening timing for an electromagnetic actuator 24 which drives this intake valve or exhaust valve.

Power supply voltage is supplied to the EDU 32 from a DC power supply 11. As examples of such a DC power supply 11, an alternator which outputs a 14V power supply voltage, or a 12V battery or the like, may be cited.

This electromagnetically driven valve includes: a valve 87, including a valve shaft, which reciprocates to and fro along the axial direction in which the valve shaft extends; a disk 74, which is a magnetic member which is linked to and drives the valve 87; a first electromagnet, which includes a first coil 80, and which attracts the disk 74 to maintain the valve closed position; and a torsion bar 68, which is an elastic member which exerts a force on the disk 74, so as to remove that disk 74 away from the first electromagnet; and an ECU 30, which controls the electromagnetic force of the first electromagnet.

When the ECU 30 weakens the electromagnetic force of the first electromagnet so that the disk 74 moves away from the first electromagnet, it reduces the electrical current which flows in the first coil towards zero after having temporarily increased it from a first holding current to a second holding current which is larger than the first holding current, and, after the disk 74 has moved away from the first electromagnet, it performs current control to flow a braking current, in order to adjust the speed of the disk 74.

The disk 74 is a oscillating member, one end of which is supported in a housing 62 so as to swivel freely, while, at its other end, it is provided with an operational portion which reciprocates the valve shaft to and fro along the direction in which the valve shaft extends.

This electromagnetically driven valve further includes a second electromagnet which attracts the disk 74 and maintains the valve in its open position, and a lower spring 86, which is a second elastic member which, by exerting its elastic force upon the valve shaft, exerts a force upon the magnetic member to remove the disk 74 away from the second electromagnet.

The electronic control unit (ECU) 30 includes a memory 31. An electrical current pattern corresponding to the output of the crank angle sensor 6 is stored as a map in this memory 31.

By moving up and down, the valve 87 opens and closes an intake valve aperture or an exhaust valve aperture which is provided in the cylinder head 10. An intermediate stem 76 is provided at an upper portion of the valve shaft 88, and extends upwards from the valve 87. A cam follower pin 75 is fixed at the upper end of this intermediate stem 76. The valve 87 reciprocates to and fro along the direction in which its valve shaft 88 extends.

A stroke ball bearing 89 is provided between the valve shaft 88 and the cylinder head 10, and thereby the valve shaft 88 is supported so as to be movable in the vertical direction. A collar 84 is provided below the intermediate stem 76. The lower spring 86 is disposed around the valve shaft 88, between the collar 84 and the cylinder head 10.

The electromagnetic actuator 24 includes the aforementioned electromagnet for opening the valve and the aforementioned electromagnet for closing the valve, both fixed to the housing 62. The electromagnet for opening the valve includes a core 78 for opening the valve, and the coil 82. And the electromagnet for closing the valve includes a core 72 for closing the valve, and the coil 80. The coil 80 and the coil 82 are wired up so that they operate together, thus constituting a monocoil structure. It should be understood that it would also be acceptable not to form this monocoil structure, but rather to control the currents in the coil 80 and the coil 82 independently with the EDU 32.

The disk 74 is attracted by this electromagnet for opening the valve and this electromagnet for closing the valve. The disk 74 is a oscillating member, one end of which is freely rotatably supported in the housing 62.

And, due to the elastic force of the torsion bar 68, which is an upper spring which acts against the lower spring 86, the disk 74 exerts a force upon the intermediate stem 76 in the downward direction, in other words in the direction to open the valve. The cam follower tip is fitted to the other end of the disk 74. And this cam follower tip 73 contacts against the cam follower pin 75 which is fixed to the upper end of the intermediate stem 76, and thereby exerts a force in the downward direction upon the intermediate stem 76, in other words in the direction to open the valve.

Conversely, the lower spring 86, by pushing upon the retainer 84, exerts a force in the upward direction upon the intermediate stem 76, in other words in the direction to close the valve.

As the resultant force of the torsion bar 68 and the lower spring 86, when the valve 87 is fully closed, a force is generated in the direction to open it; while, conversely, when the valve 87 is fully open, a force is generated in the direction to close it. Even when the distance between the disk 74 and the coil of the electromagnet which is attracting it is large and the electromagnetic force which attracts the disk 74 is weak, by taking advantage of the elastic force of the torsion bar 68 and lower spring 86 it is possible to make the size of the electromagnets relatively small.

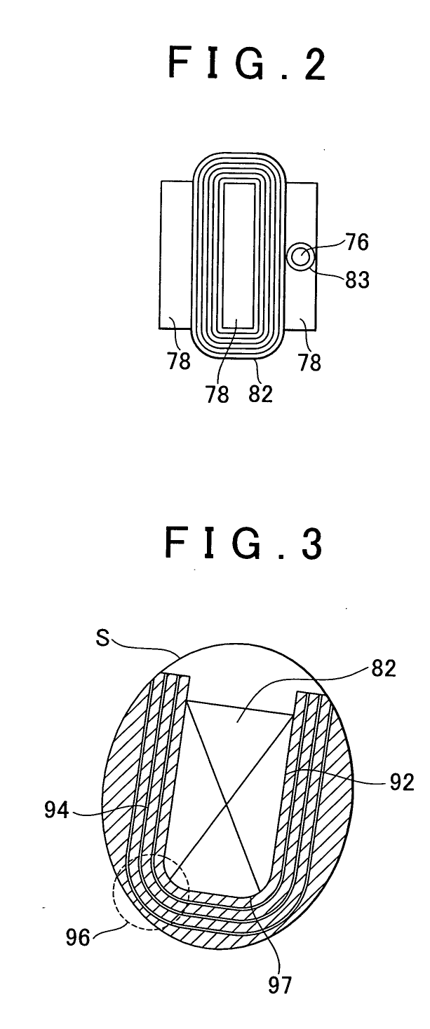

FIG. 2 is a sectional view of the FIG. 1 structure, taken in a plane shown by the arrows II-II in FIG. 1. In the embodiment shown in FIG. 2, the coil 82 is wound upon the core 78 for opening the valve. A hole is provided in a portion of the core 78 for opening the valve, in which the intermediate stem 76 and the stroke ball bearing 83 are held.

FIG. 3 is a magnified view of a portion S of FIG. 1. In the embodiment shown in FIG. 3, when an electrical current flows in the coil 82, magnetic flux lines 94 are generated, and the disk 74 is attracted.

In the research example shown in FIG. 9, since the bottom corner 197 of the coil groove 192 provided in the core 178 for opening the valve is approximately a right angle, the intervals between the magnetic flux lines in this angular portion become narrow, as shown by the portion 196, so that magnetic saturation occurs. Due to this, the problem occurs that this invites decrease of the electromagnetic force, and decrease of the responsiveness of the electromagnetic force.

By contrast since, in the example shown in FIG. 3, a radiused shape is provided at the bottom corner 97 of the coil groove 92 which is provided in the core 78 for opening the valve, accordingly the generation of magnetic saturation is alleviated, because, as shown by the portion 96, the narrowing of the gap between the lines of magnetic flux is mitigated, even at this corner portion. Due to this, the problems of decrease of the electromagnetic force, and of decrease of the responsiveness of the electromagnetic force, are improved.

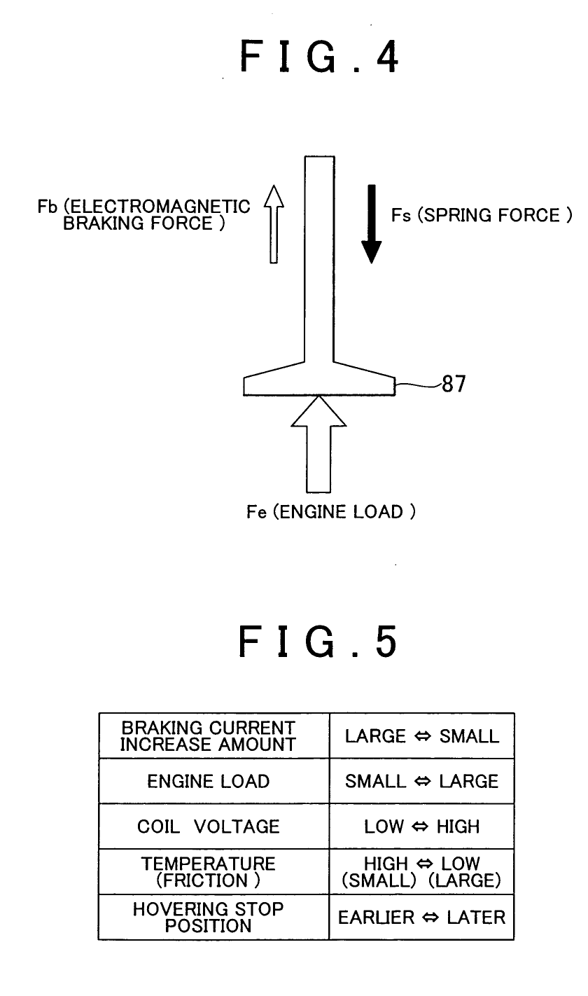

FIG. 4 is a figure for explanation of the relationship between the electromagnetic braking force Fb and the spring force Fs. When from the valve closed state the holding current is temporarily brought to zero, then the spring force Fs, as determined by the resultant of the forces exerted by the torsion bar 68 and the lower spring 86, acts on the valve 87 in the valve opening direction. Against this, an electromagnetic braking force Fb is generated by again flowing a braking current in the coil, so that the inertia of the valve should not cause overrunning.

In addition to the above forces on the valve 87, the engine load Fe, which originates in pressure increase as a result of explosion and compression within the cylinders of the engine, also acts in the direction to hinder opening of the valve.

FIG. 5 is a figure for explanation of parameters related to the braking electrical current. The braking force applied to the valve is the resultant of the electromagnetic braking force Fb and the engine load Fe shown in FIG. 4. Therefore, in order to obtain the desired braking force when the engine load Fe is small, the braking force, the resultant of the electromagnetic braking force Fb and the engine load Fe, may be made approximately constant by making large the braking current and thus the electromagnetic braking force Fb. Conversely, the braking current may be made small when the engine load Fe is large.

With regard to the coil voltage, in order to obtain the desired braking force, the braking current may be made large when the coil voltage is low; and, conversely, the braking current may be made small when the coil voltage is high.

With regard to the surrounding temperature, in order to obtain the desired braking force when the temperature is high, the braking current may be made larger to a certain extent, since the friction of the valve decreases at a high temperature. Conversely, when the temperature is low, the braking current may be made smaller to a certain extent, since the friction of the valve increases at a low temperature. For example, the surrounding temperature corresponds to the temperature of the stroke ball bearing, the valve shaft, and so on.

And, when stopping the valve at a different hovering stop position, the braking current may be changed to obtain the desired braking force. That is, when stopping the valve earlier than its standard position, it is necessary to make the braking force larger, accordingly the braking current may be increased. Conversely, when stopping the valve later than its standard position, it is necessary to make the braking force smaller, accordingly the braking current may be reduced.

In this manner, the braking current may be determined according to the engine load, coil voltage, temperature, and hovering stop target position.

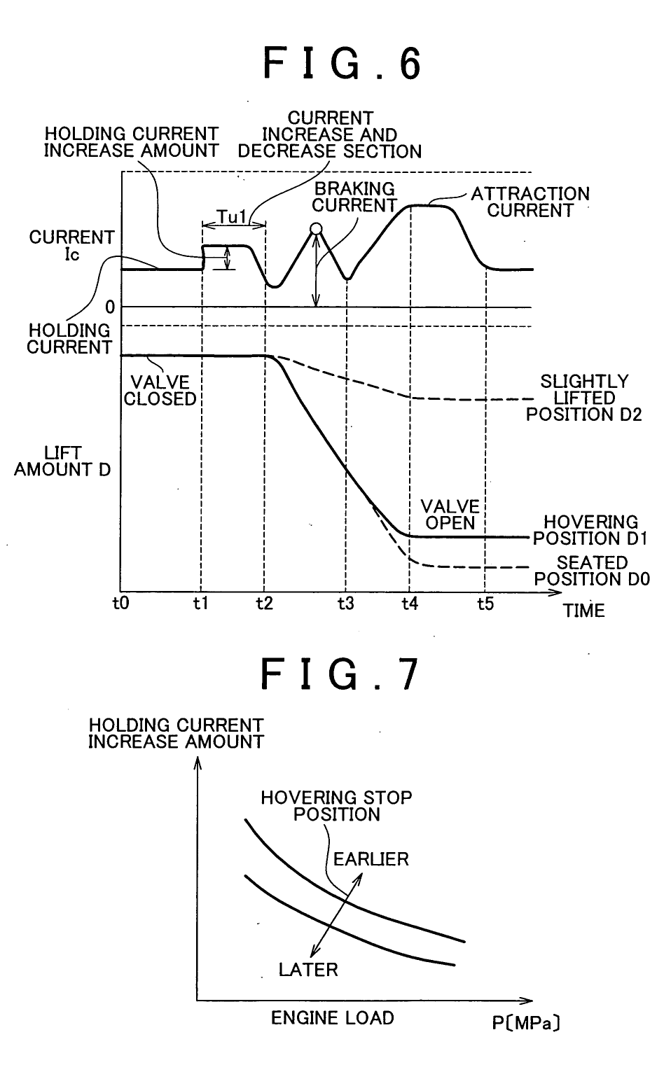

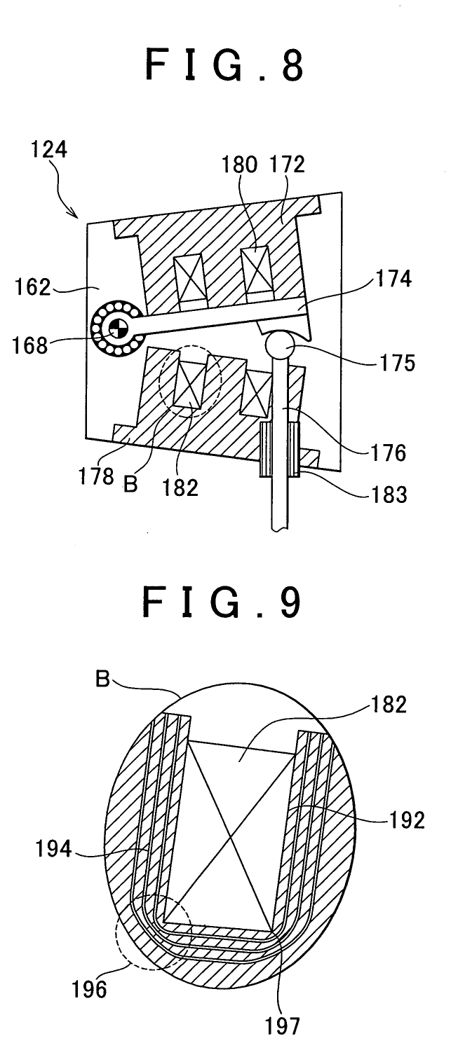

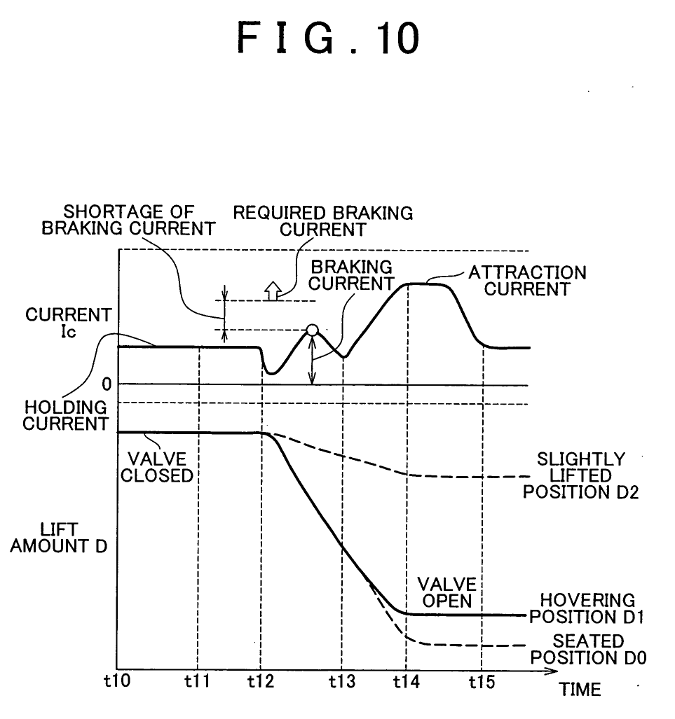

FIG. 6 is a waveform diagram for explanation of changes of the electrical current flowing in the coil. The fact that, due to demands in recent years for reduction of the power supply voltage for driving the coil, it is difficult to obtain the desired braking current, since the rise slope response of the current decreases, has already been explained with reference to FIG. 10.

By contrast, with this embodiment of the present invention, a current increase interval is provided between the time points t1 and t2 in FIG. 6, in other words, in the final portion of the period in which a holding current flows for maintaining the valve just as it is in the closed position.

At the time points t0˜t1, the necessary holding current is flowed for attracting and holding the disk 74 in a stable manner. In order to reduce the consumption of electrical power, in other words in order to enhance the fuel consumption, this holding current should be made as small as possible.

And the current is increased in the current increase interval between the time points t1˜t2, in order to flow a braking current, in addition to the minimum level of holding current. And at the time point t2 the current is reduced so as to be lower than the holding current.

Although at the time points t2˜t3 a braking current does, the current cannot rise immediately, due to the influence of the inductance of the coil. Accordingly, by setting a current increase corresponding to this necessary braking current at the time points t1˜t2, it is possible to flow the necessary braking current at the time points t2˜t3. By flowing this braking current, it is possible to adjust the speed of the disk and its kinetic energy at the time point at which the disk approaches the neutral position of the spring.

And, by flowing the attraction electrical current in the coil at the time point t3 at which the disk passes the neutral position of the spring, it is possible to bring the valve open position determined between the time points t4˜t5 to the hovering position D1 or to the slightly lifted position D2. After the time point t5, the necessary holding current flows for maintaining this valve open position in a stable manner.

It should be understood that the beneficial effect that the braking current can quickly rise would also be obtained by also increasing the electrical current during the interval from the time point t0 to the time point t1 as well, but, in this embodiment the energy efficiency is enhanced by reducing the holding current and taking a short period directly before the disk 74 separates from the core 72 for closing the valve as the current increase interval.

In FIG. 5, a method has been explained of obtaining the desired braking force by varying the braking current according to various parameters. In FIG. 6, a method has been explained of increasing the holding current at the time points t1˜t2 in order to flow the required braking current. Accordingly, there is also a relationship between the increase amount of the holding current and the various parameters of FIG. 5.

Thus if it is obtained in advance, in what manner this braking current increase amount is determined according to these parameters, and this type of relationship is registered in a map, then it is possible to obtain the coil current value for the time points t1˜t2 directly, by referring to this map using the various parameters as arguments.

FIG. 7 is a figure showing an example of a map which determines the amount of increase of the holding current. Referring to FIGS. 5 and 7, the map is made so that, when the engine load P [MPa] increases, the increase amount of the braking current decreases; this is shown as a graph for each hovering stop target position.

Furthermore, in FIG. 7, when the target stop position is earlier, the graph shifts to the side where the braking current increase amount is larger; while, when the target stop position is later, the graph shifts to the side where the braking current increase amount is smaller.

Although a map of engine load and hovering stop target position, which is a representative example, is shown in FIG. 7, a map may be created by selecting any of the parameters shown in FIG. 5.

As explained above, in this embodiment of the present invention, by temporarily flowing an electrical current which is greater than the holding current when the holding current drops, it is possible to enhance the responsiveness of the current control even at low voltage, and thus to enhance the reliability of control. Furthermore, as compared with the case in which the groove shape of the core which holds the coil is angular, the intervals between the lines of magnetic flux are more even, so that it is possible to avoid magnetic saturation.

The embodiment described above should not be considered as being limitative, since all its features have only been disclosed by way of example. The scope of the present invention is to be specified by the appended Claims, and not by any of the details of the above explanation; various changes in any embodiment of the present invention may be contemplated, provided that they are equivalent in meaning as far as the scope of the Claims is considered, and that they are within the range thereof.

What is claimed is:

1. An electromagnetically driven valve, comprising:
a valve, including a valve shaft, which reciprocates to and fro along a direction in which the valve shaft extends;
a magnetic member which is connected to and drives the valve;
a first electromagnet, including a first coil, which attracts the magnetic member and keeps the magnetic member in a predetermined position;
a first elastic member which applies, to the magnetic member, a force to remove the magnetic member from the first electromagnet; and
a control device which performs electrical current control so as, when weakening the electromagnetic force of the first electromagnet and separating the magnetic member from the first electromagnet, to reduce the electrical current which flows in the first coil towards zero, after having temporarily increased the electrical current from a first holding current to a second holding current which is larger than the first holding current, and then, after the magnetic member has separated from the first electromagnet, so as to flow a braking current for adjusting the speed of the magnetic member.

2. The electromagnetically driven valve according to claim 1, wherein
the electromagnetically driven valve is a valve which opens and closes a gas conduit to a combustion chamber of an internal combustion engine, and the value of the second holding current is determined according to the load of the internal combustion engine.

3. The electromagnetically driven valve according to claim 1, further comprising:
a valve drive unit which flows an electrical current to the first coil so as to drive the first electromagnet; and a DC power supply which supplies DC power voltage to the valve drive unit; wherein the value of the second holding current is determined according to the power supply voltage.

4. The electromagnetically driven valve according to claim 1, wherein
the value of the second holding current is determined according to the temperature of the environment in which the electromagnetically driven valve operates.

5. The electromagnetically driven valve according to claim 1, wherein
the value of the second holding current is determined according to a target position for the valve to be stopped, after the magnetic member has been separated from the first electromagnet.

6. The electromagnetically driven valve according to claim 1, further comprising
a magnetic material core in which is provided a coil groove, in which at least a portion of the first coil is housed, wherein
the magnetic material core attracts the magnetic member towards an open side portion of the coil groove, and the coil groove has an approximately quadrilateral shape in cross section in a direction orthogonal to the winding direction of the coil, and corner portions of the coil groove, at the bottom portion of the opposite side of the quadrilateral to the open side portion thereof, are radiused.

7. The electromagnetically driven valve according to claim 1, wherein
the magnetic member is a oscillating member, one end of which is supported so as to swivel freely upon a base member, and which is provided, at other end, with an operation portion which reciprocates the valve shaft to and fro along the direction in which the valve shaft extends.

8. The electromagnetically driven valve according to claim 1, wherein the predetermined position is a valve closed position, and
the electromagnetically driven valve comprises: a second electromagnet which attracts the magnetic member and holds the magnetic member in a valve open position; and
a second elastic member which, by exerting an elastic force on the valve shaft, exerts a force on the magnetic member to remove the magnetic member from the second electromagnet.

9. An electromagnetically driven valve, comprising:
a valve, including a valve shaft, which reciprocates to and fro along a direction in which the valve shaft extends;
a magnetic member which is connected to and drives the valve;
a first electromagnet, including a first coil, which attracts the magnetic member and keeps the magnetic member in a predetermined position;
a first elastic member which applies, to the magnetic member, a force to remove the magnetic member from the first electromagnet; and
a core of magnetic material, in which a coil groove is provided which houses at least a portion of the first coil, wherein:
the core of magnetic material attracts the magnetic member towards an open side portion of the coil groove, and
the core groove has an approximately quadrilateral shape in cross section in a direction orthogonal to the winding direction of the coil, and corner portions of the core groove, at the bottom portion of the opposite side of the quadrilateral to the open side portion thereof, are radiused.

10. The electromagnetically driven valve according to claim 9, wherein
the magnetic member is a oscillating member, one end of which is supported so as to swivel freely upon a base member, and which is provided, at other end, with an operation portion which reciprocates the valve shaft to and fro along the direction in which the valve shaft extends.

11. The electromagnetically driven valve according to claim 9, wherein the predetermined position is a valve closed position, and
the electromagnetically driven valve comprises: a second electromagnet which attracts the magnetic member and holds the magnetic member in a valve open position; and
a second elastic member which, by exerting an elastic force on the valve shaft, exerts a force on the magnetic member to remove the magnetic member from the second electromagnet.

12. The electromagnetically driven valve according to claim 11, wherein
the second electromagnet includes a second coil which is wired up to the first coil, and the control device performs control so as to flow equal electrical currents in the first coil and in the second coil.

13. The electromagnetically driven valve according to claim 12, wherein
the control device performs control, after having reduced the electrical current which flows in the first and second coils to zero from a predetermined current value for holding current, so as to flow in the first and second coil a current for attracting the magnetic member against the second electromagnet.

14. A method for driving an electromagnetically driven valve including:
a valve, including a valve shaft, which reciprocates to and fro along a direction in which the valve shaft extends;
a magnetic member which is connected to and drives the valve;
a first electromagnet, including a first coil, which attracts the magnetic member and keeps the magnetic member in a predetermined position; and
a first elastic member which applies, to the magnetic member, a force to remove the magnetic member from the first electromagnet, the method comprising:
when weakening the electromagnetic force of the first electromagnet and separating the magnetic member from the first electromagnet, temporarily increasing the electrical current which flows in the first coil from a first holding current to a second holding current which is larger than the first holding current;
separating the magnetic member from the first electromagnet by weakening the electromagnetic force of the first electromagnet by reducing the electrical current which flows in the first coil towards zero; and
after the magnetic member has separated from the first electromagnet, flowing a braking current for adjusting the speed of the magnetic member in the first coil.
